(19) United States
(12) Patent Application Publication
(10) Pub. No.: US 2020/0320894 A1
(43) Pub. Date: Oct. 8, 2020

(54) INTERACTIVE COACHING INTERFACE

(71) Applicant: Financial Finesse, Inc., El Segundo, CA (US)

(72) Inventors: Liz Davidson, El Segundo, CA (US); Dusten Randal Salinas, San Pedro, CA (US); Nicholas Adam Lapworth, Santa Monica, CA (US)

(73) Assignee: Financial Finesse, Inc., El Segundo, CA (US)

(21) Appl. No.: 16/839,636

(22) Filed: Apr. 3, 2020

Related U.S. Application Data
(60) Provisional application No. 62/829,930, filed on Apr. 5, 2019.

(51) Int. Cl. G09B 7/00; G09B 19/00; G06N 3/00; G06N 20/00; G06N 5/04

(52) U.S. Cl. CPC G09B 7/00; G09B 19/00; G06N 5/04; G06N 20/00; G06N 3/006

(57) ABSTRACT

A virtual, interactive coach that operates through a graphical user interface of a computing device and associated computing system. This includes presenting interactive questions to the user that acquire input about the user's profile data, financial data, financial goals, and other relevant information. The system identifies the most relevant questions and action items to present to each user using an artificially intelligent algorithm.

### CROSS REFERENCE TO RELATED APPLICATIONS

This application claims priority to U.S. Provisional Application No. 62/829,930, filed Apr. 5, 2019, titled INTERACTIVE COACHING INTERFACE, the contents of which are incorporated herein by reference.

### FIELD

The present invention is directed to interactive computer interfaces and displays.

### BACKGROUND

The following description includes information that may be useful in understanding the present invention. It is not an admission that any of the information provided herein is prior art or relevant to the presently claimed invention, or that any publication specifically or implicitly referenced is prior art.

Currently, many financial coaching or other virtual coaching software presents a pre-defined, linear set of questions that are hard coded to be asked to each user to acquire data from the user through the user interface. Thus, these systems present each of the users with the same set of questions and cannot adapt to each user's individual situation.

### SUMMARY

Presently, automating a computer interface to provide an interactive and automatic virtual financial assistance requires heavy human intervention and supplementation. For instance, some financial coaching or other virtual coaching software presents a pre-defined, linear set of questions that are hard coded to be asked to each user to acquire data from the user through the user interface. Thus, these systems present each of the users with the same set of questions and cannot adapt to each user's individual situation.

Thus, these platforms present irrelevant or non-optimized questions to the users, or cannot provide specifically important questions to particular users. For instance, if each user is presented the same set of questions, or even uses the same fixed decision tree to present questions, there are only so many questions that could be asked without overwhelming the user. Thus, those hard coded question structures limit the amount of specific, niche, or individualized questions that can be ask and thus sacrifice precision. Also, these structured frameworks prevent the platforms from identifying new questions automatically when circumstances may change for the user, and usually requires going through an entire set of questions again to provide updates. Furthermore, there is no currently available interactive methods to track a user's financial progress and to interactively keep track of the next steps a user should take to improve their position.

Accordingly, the inventor(s) have developed systems and methods to implement a virtual, interactive coach that operates through a graphical user interface of a computing device and associated computing system. This includes presenting interactive questions to the user that acquire input about the user's profile data, financial data, financial goals, and other relevant information. The system identifies the best and most important questions to present to each user using an artificially intelligent algorithm for weighing the input data from the user and determining which questions are most relevant and displaying those questions. For instance, if initial answers data from questions reveals the user has debt reduction as a priority, the platform may present questions on the interface that relate to determine the types of debt the user has, and other factors relevant to debt and payoff strategy.

Additionally, while there are a variety of ways to train the machine learning models that recommend action items and questions, in some examples, the platform is trained in a unique and advantageous way—using human financial planners to label and train data. Specifically, the system may utilize actual human financial planners to train the system. For instance, for a given user and input data received from the training user, the planner can use a training module to tag or input questions and action items to train the algorithms based on their recommendations. This will allow the training data to be labelled based on the subjective labelling by a set of financial planners. The inventor(s) surprisingly found that although determinations by financial planners may be subjective at least partially, the training method produced good and consistent results—even though there is no black-and white quantitative feedback mechanism for training.

In other examples, the system may be trained using a financial wellness score, or other quantitative values to feedback into the models. For instance, with debt reduction as a priority, the system could track the impact the questions and action items has on the debt of various users, to prioritize the most effective questions and action items.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 depicts an example of a schematic diagram showing a system for implementing a virtual coaching software platform.

FIG. 2 depicts an example of a schematic diagram showing a system for implementing a virtual coaching software platform.

FIG. 3 depicts an example of a flow diagram illustrating a process for implementing a virtual coaching software platform.

FIG. 4A depicts an example user interface implementing a question to identify goals of the user.

FIG. 4B depicts an example user interface implementing a question.

FIG. 5 depicts an example user interface implementing an action item.

FIG. 6 depicts an example user interface implementing a goal and associated question triggered by previous data input.

FIG. 7 depicts an example user interface implementing several action items along a vertical priority hierarchy.

FIG. 8 depicts an example user interface implementing several action items along a vertical priority hierarchy.

FIG. 9 depicts an example user interface implementing a question regarding debt payments.

FIG. 10 depicts an example user interface implementing a financial wellness score by category and goals.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

Examples of financial wellness scores, categories and subcategories of financial wellness, action items as part of a wellness plan, financial goals and preferences of users, and other aspects related to the platform disclosed herein are described in, for example, US Patent Publication 2011/0225079, filed on Apr. 21, 2011 titled Method and System for Personalized Education, by Davidson, which is incorporated by reference herein in its entirety.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The following examples are provided to better illustrate the claimed invention and are not intended to be interpreted as limiting the scope of the invention. To the extent that specific materials or steps are mentioned, it is merely for purposes of illustration and is not intended to limit the invention. One skilled in the art may develop equivalent means or reactants without the exercise of inventive capacity and without departing from the scope of the invention.

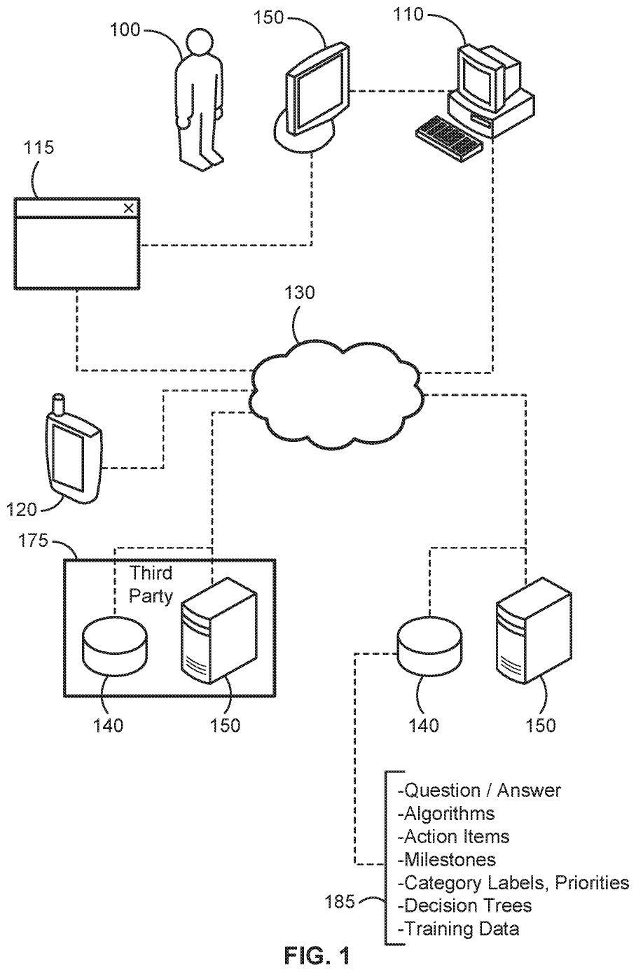

FIG. 1 illustrates an example overview of a system for implementing a virtual coach. For instance, the system may include a user 100 that interacts with a display 150, computing device 110 and a mobile device 120. In some examples, the user 100 will interact with a user interface 115 on one of the various computing devices. The mobile device 120, computing device 110, display 150, interface 115, and another computing device may all be connected over various combinations of networks 130, that may include wired, wireless, Bluetooth, and any other known wired or wireless method of electronic communication.

The computing devices may be connected to a server 150 and database 140 over the network 130 that supports the virtual coaching platform. In some examples, the server 150 and database 140 will host the coaching platform, and in other cases may only provide part of the hosting, and some of the platform may be run locally on computing device 110 or mobile device 120. This may include various algorithms that may be stored locally on the mobile device 120 or computing device 110 or on the server 150 and database 140.

In some examples, some of the data 185 will be imported from a third party 175 server 150 and database 140 which may be connected to the system. For instance, the third party 175 server and database 140 may store and update financial data from the user 100. In some examples, this could be a bank or other financial institution, or a third party broker. In some examples, an API will be utilized to translate financial data from the third party 175 server 150 and database 140 to regularly update the financial data or other data 185 stored on the system's database 140.

### Database and Server Data

In some examples, the database 140 (and/or the computing device 110, or mobile device 120 or other associated computing devices) may include various data 185 that will be referenced to implement the coaching system, including:
questions;
answers;
algorithms;
user profiles;
training data for algorithms that may be referenced to certain algorithms or category labels;
action items, and
milestone data.

In some examples, the database 140 may include category labels references to each of the data entries in the system, including category labels that may be linked to certain goals of the user. In other examples, the category labels could be related to general topics that the financial planners like to address, including debt reduction, saving, children, life events, etc.

Additionally, the database 140 may store algorithms and associated training data for various coaching services provided by the system. For instance, the algorithms may include:
decision trees;
decision trees that guide the initial question and answer input;
trained algorithms referenced to certain category labels;
regression algorithms;
algorithms trained using back propagation; and
others.

The algorithms may each include category labels, and may be trained with training data specific to certain category labels or may be agnostic to category labels. Furthermore, the disclosed technology may include priorities and decision trees for when to utilize certain decision trees in implementing, questions, action items, milestones, and other features.

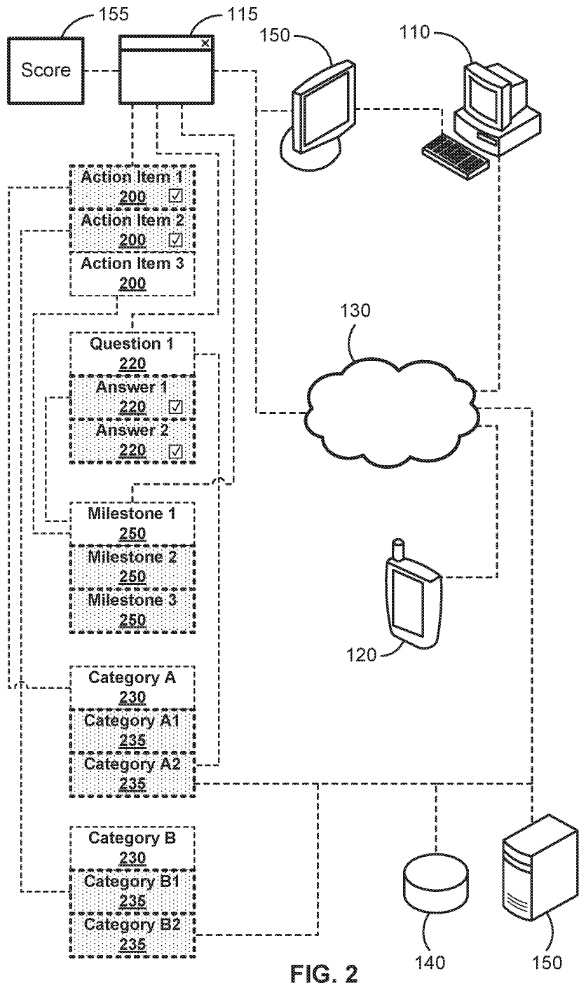

FIG. 2 illustrates an example of the various features that will be displayed on a display 150 and interface 115, and will also be items the user 100 may interact with on the interface 115. For instance, the user 115 may indicate certain interactive features may be completed or provide input for certain interactive features.

The interactive features on the interface 115 may include boxes that may be checked with a mouse or other user interface tools, selecting multiple choice answers 220, entering quantitative values in a box, and other interaction methods.

Additionally, the interface 115 may display a financial wellness score 255. The financial wellness score may include quantitative assessments of the user's financial health based on the user's debt, savings, and other categories, and may be an overall score and/or may be broken down into categories such as debt, retirement, etc.

For instance, the disclosed technology may display various questions 210 to the user on the interface 115, and the questions 210 may have various answers 220. The questions 210 may be text strings (or could be audibly read through a speaker) displayed on the interface 115, and may include potential answers 220. The answers 220 could be a variety of formats, including:
multiple choice;
boxes for entering a quantitative value, for instance a financial value;
yes/no; or
others.

As answer 220 data or other input data is received, it may be stored locally on a user's 100 computing device and/or stored in the database 140, referenced to certain category labels and an ID that uniquely identifies the user.

### Action Items

Additionally, the platform may display various action items 200 at various times. In some examples, the action items 200 will be displayed as a vertical or horizontal list of tiles or boxes, which each action item 200 including various links to content, an indicator (e.g. a box) for the user 100 to click on or otherwise indicate an action item is completed. In some examples, the action items 200 will include a button on the interface 115 that will be a direct link to where the user 100 may take action.

Action items 250 may include category and sub-category level, providing a labeling taxonomy to organize the action items 200 using the same categorizations as other features (e.g. milestones). In some examples, the action items 200 will be arranged in a priority of the system, that will be based on various outcomes. For instance, the action items 200 may be displayed in terms of their impact on the financial wellness score 255, how early or often a financial planner would recommend the action item based on training data or other priority basis. In some examples, action items 200 within a category label 235 (or one type of goal) may have a hard coded priority or decision tree. This may include eldest child, youngest child relationship among actions items, wherein a user 100 must complete a certain action item to get to the next action item.

### Milestones

Additionally, the interface 115 may display various milestones 250. Milestones 250 may include category and sub-category level, providing a labeling taxonomy to organize the milestones using the same categorizations as other features (e.g. action items). Milestones 250 may include a text string for a milestone name, some content like an icon, and have priorities or hierarchies, to be able to arrange them by categories and sub-categories so some milestones trump others etc. Additionally, each milestone 250 may have threshold most complete items or data that must be confirmed.

The milestones 250 could be various financial wellness indicators, that may include being debt free, paying down half of debt, saving a certain amount toward retirement, etc. In some examples, milestones 250 may be displayed as a percentage progress towards a goal (e.g. 58% progress to being debt free). The milestones 250 may be displayed in a variety of ways that includes on a timeline. Additionally, the milestones 250 may impact the action items 200, questions 210, and other features of the platform.

### Category Labels

The data associated with interactive features including, training data, algorithms, and other data may include category labels 230. The category labels may be related to certain goals of the user, for instance: (1) debt reduction, (2) saving for some event, (3) purchasing a house, (4) maximizing financial wellness score 255, and (5) others. In some examples, category labels may relate to general categories of financial wellness that include (1) debt reduction, (2) saving, (3) emergency fund, (4) retirement planning, (5) and others.

In some examples, the category labels 230 may include subcategories 235 that have parent—child relationships with the category label 230. The category labels 230 and subcategory labels 235 may be utilized to label the various data associated with each feature of the disclosed technology. For instance, training data may all of a category and/or subcategory label referenced to it in the database 140, and therefore the algorithms related to a certain category may be easily updated or personalized once new training data is received.

The category labels 230 may be utilized with the machine learning algorithms to present questions only within a certain category that is relevant to a particular user 100. For instance, if a user is interested in debt reduction, certain questions 210 related to debt reduction may be displayed on the interface 115, depending on the priority indicated in the training data or whether certain questions 210 reach a threshold importance or relevance based on the input data and the machine learning model outputs.

### User Profiles

The technology may store various data, including profile data 305, relating to a user profile of a user 100. This may include various answers 220 to questions presented to the user or may be determined through other data received by the technology. For instance, additional data that may be added to the user profile may include:
user clicks on various hyperlinks presented to the user on the interface;
page clicks;
data on quantity and type of interactive features used. This may include blog pages, article pages, streaming content, live workshops, webcasts, interactive calculators, and other resources.
transitions from offline (coach direct or group interaction) to online (virtual financial coach) or online to offline;
responsiveness to versions of questions 210—in some examples, various questions 210 may have a variety of different versions, and each version may have a style or category label, related to a particular communication style;
responsiveness to communication channels—questions 210 or other content may be presented to the user or sent to the user using a variety of communication channels and formats, including push notifications, emails, questions 210, or other formats and channels;
financial information—bank, loan, credit card, insurance, tax, healthcare, estate planning, etc.; and
personal information—age, etc.

### Interactive Elements

The technology may also trigger various interactive elements at various times, along with certain milestones 250, action items 250, or independent of other triggered items. These items may include:
communications—including in application notifications, push notifications, emails, SMS messages, or others;
webcast links;
live personalized coaching interactions; and
sources—including blogs, articles, streaming content, calculators, tools, or others.

In some examples, a coaching device or computing system may interact with the user 100 through the interface to perform live coaching sessions. This may involve a human coach that may provide additional data input into the user's 100 profile and/or account. For instance, the technology may receive assignment of action items 250, milestones 250, or resources provided manually through an electronic interface to a device associated with a human coach. Additionally, the coach may provide answers 220 to questions as well on behalf of the user 100.

### Methods for Implementing a Virtual Coach

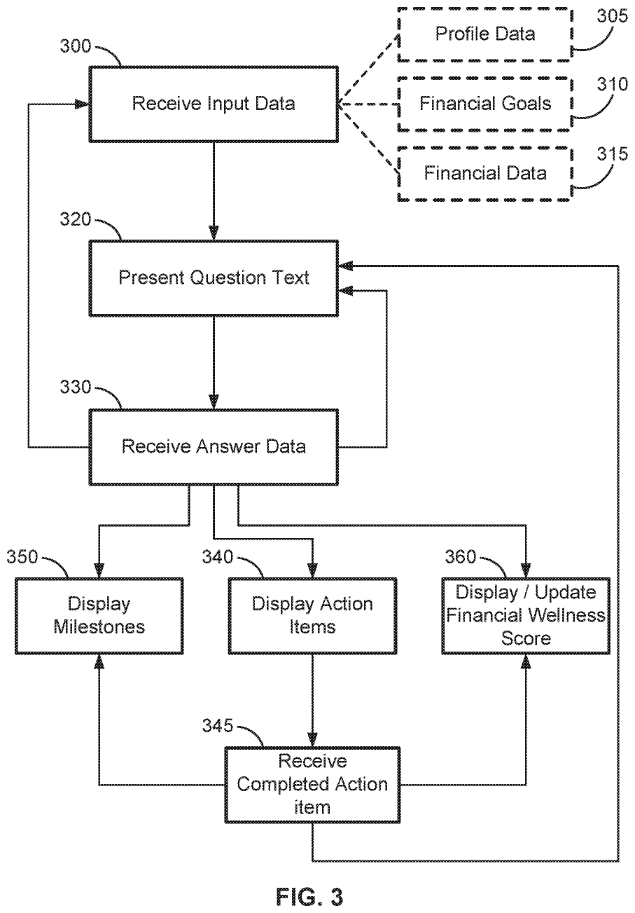

FIG. 3 illustrates an example of a method for implementing the disclosed platform on the various systems and hardware. The system may be implemented by a variety of flow logic combinations and permutations of the examples disclosed below and herein.

In some examples, the disclosed technology may receive input data 300 from various sources that may include profile data 305, financial goals or other goals 310, financial data 315 which may include qualitative or categorical financial related data, inputs from a coaching device on behalf of the user 100, and other input data 300. As described above, this may include financial data from third party sources 175, that may include a regular query of a third party server 150 and database 140 hosting a user's 100 bank account information, or other financial accounts to update all of the data referenced to a particular user 100. Additionally, the input data 300 may be received from answer data 330 input from the user 100 through the interface 115 or from the coach's device on behalf of the user 100.

Furthermore, input data may be associated with particular users 100 as discussed above, including the history of user interactions, engagement/usage data (e.g. clicks, scrolling, time, hyperlink clicking, etc.). This may accumulate as a particular user 100 interacts with the disclosed technology over time.

### Initial Data Input for User

In some examples, the platform 300 may request a standard set of data from the user 100 through questions 210 and answers 220. These may be the same or similar for each new user 100 and may include survey questions. In some examples, the initial data input 300 flow logic displayed by the computing device to a user 100 may be determined by a decision tree that directs the interface 115 to display a specific set of initial questions 210 and asks follow up questions 210 given certain answers 330 or other data 300. In other examples, a machine learning algorithm may be utilized to determine which questions to present to the user 100 initially. This could be based on the experience of the training data—for instance that all users 100 are asked a first set of initial questions by the training data labeled by financial planners.

In other examples, there may be an initial hard coded survey of questions followed by a decision tree or other machine learning algorithm that is utilized by the platform to select additional relevant questions 320 to display to a user 100. Furthermore, a coach through there own computing device may answer questions 320 on behalf of the user 100.

In some examples, the initial questions 320 may be displayed on the interface 115 to establish: (1) a baseline financial health of the user 100 related to the wellness score 255 or to establish a baselines wellness score, (2) establish the financial goals 310 of the user, including debt reduction, etc., (3) input various basic profile data that may include age, health history, or (4) other various questions to identify potential financial vulnerabilities of the user.

Once the initial input data 300 is received, the platform may then display a list of action items 340 and/or milestones 360 to the user 100 on the interface 115. As described above, the action items 340 may be prioritized based on various items, including the user's 100 preferred goals 310, the user's 100 identified vulnerabilities, or training data that indicates the priority of the action items 200 that a planner would recommend (including data provided by a coach device). Additionally, after the initial input, the financial wellness score 255 may be updated or displayed 340.

### Ongoing Interactive Interface

After the initial input and display of action items 200 and milestones 250, the platform may receive input data 300 or other inputs from the user 100 through the interface 115 (or from a coach device) that trigger additional questions 320 to be presented, additional action items 200 to be displayed 340, or additional milestones 350. These triggers may automatically cause the system to reprocess the data for a user 100, including the profile data 305, and user interaction data, to determine whether any new action items 200, milestones 250, or other items need to be displayed or information needs to be received. In some cases, these triggers could also cause the system to query linked user financial accounts through APIs that request an update to the user's 100 financial data.

In one example, the system (through an API) may receive updated financial data from a third party 175 server 150 that may trigger additional questions 320, action items 340, or display a new milestone 350. In some examples, the financial data may indicate an action item 200 is completed and automatically close it out (for example a loan has been paid off).

In other examples, a user 100 interacting with the interface 115 to indicate an action item 200 is completed 345 may trigger new questions 320, may update the financial wellness score 360, or display new milestones 350. For instance, in some examples, the user 100 may check the box that an action item 200 has been completed. In that case, there may be sub-action items 200 associated with a user 100 goal 310 that should be completed next, that may be automatically displayed 340.

Additionally, the platform may then display additional questions 320 that relate to that action item 200 or the system has been trained to ask once a certain action item 200 is completed. As an example, once input data 300 is received that indicates debt has been paid off, the platform may present questions 210 to the user 100 to determine whether the user would like to revisit their saving goals 310, and perhaps adjust how much they are saving on a periodic basis.

The platform may also base future action items 200 and milestones presented to the user 100 based on the action items 200, and other input provided by a coach (e.g. a human financial planner) previously through the platform to the user 100. Accordingly, this advantageously allows the disclosed virtual coach to utilize information from a coach device (provided by a human financial planner) seamlessly with the recommendations and additions of the platform.

The input data 300 may also include engagement with action items 200 on the interface 115 for a particular user 100. For instance, the engagement metrics that may be tracked by the platform may include:
amount of time spent reading links;
whether a user 100 clicks on a link;
whether a user 100 clicks certain types of links in certain categories;
whether a user 100 responds to certain communication styles or channels, including for instance, a live coach interaction versus the virtual platform;
content preferences for a user 100 based on past usage data;
how often the user 100 logs into the program;
the types of action items 200 the user engages with, including the category label; and
others.

This information may feedback into the algorithms to determine or weight: (1) future action items 200 or questions 210 to present to a particular user 100 (2) which action items 200 users 100 in general are more likely to benefit from; (3) demographics of users 100 more likely to engage in certain action items 200. Thus, the system can personalize action items 200 and questions 210 based on the profile data of a particular user 100, for instance. In other examples, the engagement with action items 200 can feedback into the wellness score 255 or other scoring mechanisms.

### Logic for Displaying Features on User Interface—Algorithms

As described above, the platform will intelligently display questions 320, action items 340, milestones 350 and other features to the user 100 on the interface 115. Various combinations of algorithms and hard coded decision trees or other logical flows may be utilized at various stages of the user 100 interaction.

In some examples, machine learning algorithms will be utilized that will be trained to recommend certain questions 210 or action items 200 based on the current input data 300 and various other sources of information as described herein. For instance, in some examples a machine learning model may be utilized to determine which interactive features to display. For instance, a decision tree, neural net, and any other combination of or types of suitable machine learning models may be utilized.

In some examples, the disclosed machine learning models will be trained by inputting a financial planner's manually recommend questions 320 and action items 340 based on an example or current user 100 input data 300. This will allow the algorithm to be trained by manual recommendations from financial planners, and will for instance, be able to present questions 210 or action items 200 when the model determines the question 210 or action item 200 would be suggested over a threshold probability. In some cases, questions 210 that are recommended will come as a series of questions 210 (through a sub-decision tree) that will be asked once a threshold probability is reached.

In other examples, the platform may be trained based on feedback from the specific goal 310 of a user 100. For instance, if a user 100 intends on reducing debt, the platform may train the algorithms by learning how much certain action items 340 impact the debt of a user over a longer period of time. In other examples, this may optimize algorithms initially trained using financial planners. In still other examples, the models may be trained using the wellness score 255 as feedback, as historical user engagement with certain action items 200, etc.

In some examples, questions 320 will be prioritized based on the likelihood they will lead to the threshold removal or addition or prioritization of certain action items 340.

In some examples, questions 210 will have parent-child relationships, so once the disclosed technology's algorithm determines a base question should be triggered based on the input data 300, a series of child questions 210 may also automatically be asked. Additionally, answers 220 may have various triggers including to display the next question 210, to trigger or unlock a list of questions 210 based on the current input data 300, a profile trigger (to ask more questions 210 regarding the user's profile fields), milestone 250 trigger—add a new milestone 250, score value trigger—edit or update the score value 255, etc.

### Example User Interfaces and Implementations

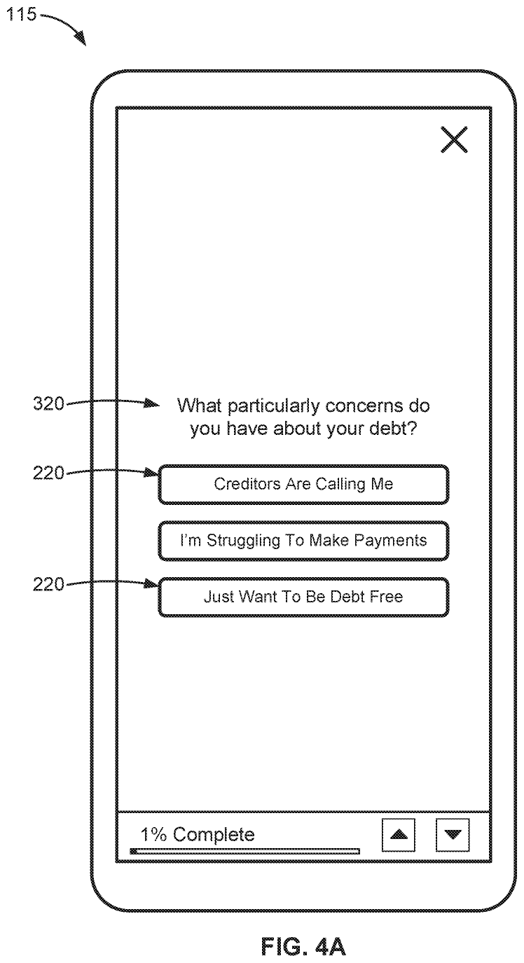

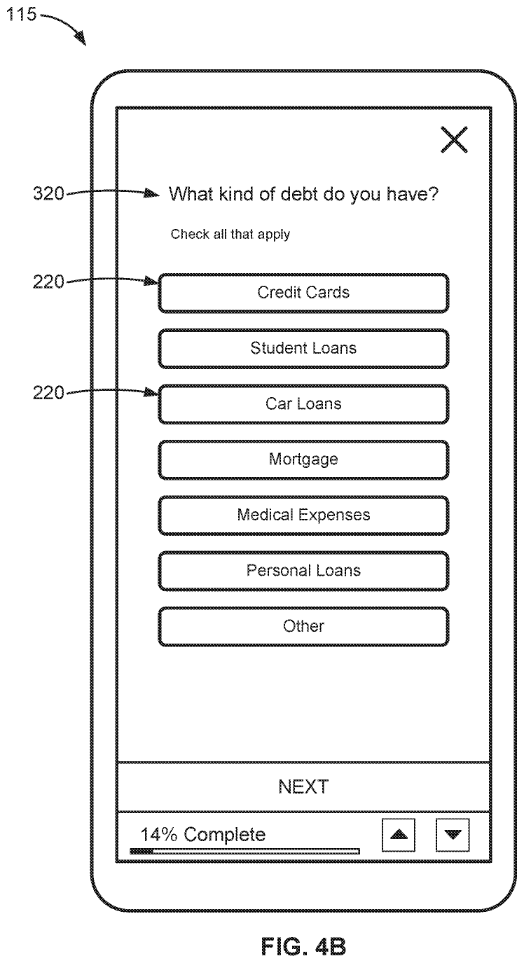

FIG. 4A is an example user interface 115 with an initial question 320 to the user 100 to assess the user's goals 310 with some granularity. This will be useful in determining which further questions 210 and action items 200 to present to the user.

FIG. 4B illustrates an example user interface 115 with another initiation question 320 presented to the user 100 to determine the type of credit card debt the user 100 would have. In this example, this question will likely have hard coded, for instance as a decision tree that presents follow up questions 210 depending on which types of debt the user 100 indicates it has in its answers 220. Also, in this case, the user 100 may click more than one type of debt on the user interface 115. For instance, if the user indicates they have student loans, some child or follow up questions 210 would be presented that ask the user specific details about the student loans.

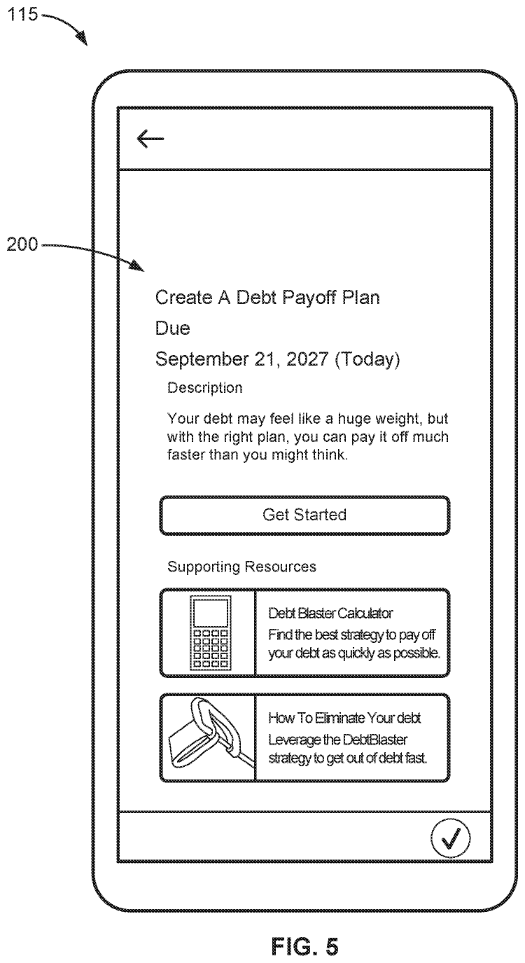

FIG. 5 shows an example user interface 115 of an action item 200 that includes paying off a debt plan based on a user's 100 previous answers 220 regarding debt, including specific figures on the amount of debt (and based on other data discussed herein). For instance, the action item 200 includes text, a get started button, and a status indicator on the lower right. Additionally, the action item 200 provides resources to the user 100 in the interface 115 to help them learn about the action item. The user's engagement with the action item 200 could be tracked to determine how it impacts future action items 200, questions 210, etc.

Some interfaces 115 may include separate windows or dialogue boxes for live interactions (e.g. messages or video chats) with financial planners. This will allow the user 100 to distinguish between virtual advice and from that of a human planner.

When certain action items 200 are triggered, other content, messages, and resources may be triggered. In other examples, the algorithms used to trigger an action item 200 may only trigger content or messages. These may be in the form of application notifications, push notifications, emails, SMS messages, or other channels and a variety of formats. In some examples, the algorithm my trigger a recommendation that the user 100 speak live to or communicate with a financial planner, if for instance, there is a low level of confidence in the algorithms suggested action items, resources, or other outputs.

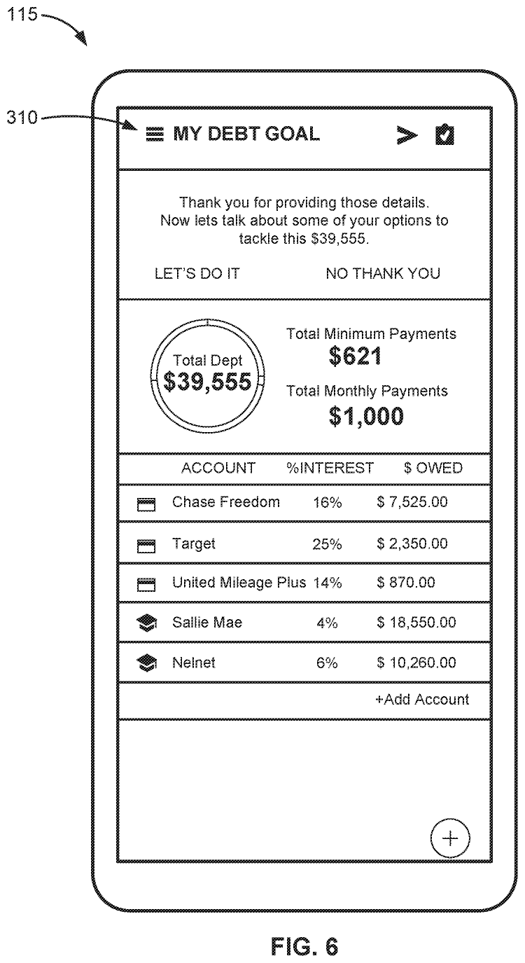

FIG. 6 shows an example user interface 115 with a milestone 250 or goal 310 and progression towards the goal 310. Additionally, after the user 100 determined that removing debt is a goal 310, the disclosed technology will trigger follow up questions 210 to determine how the user 100 would best like to tackle the debt. This will help the system to determine action items 200 that address the debt.

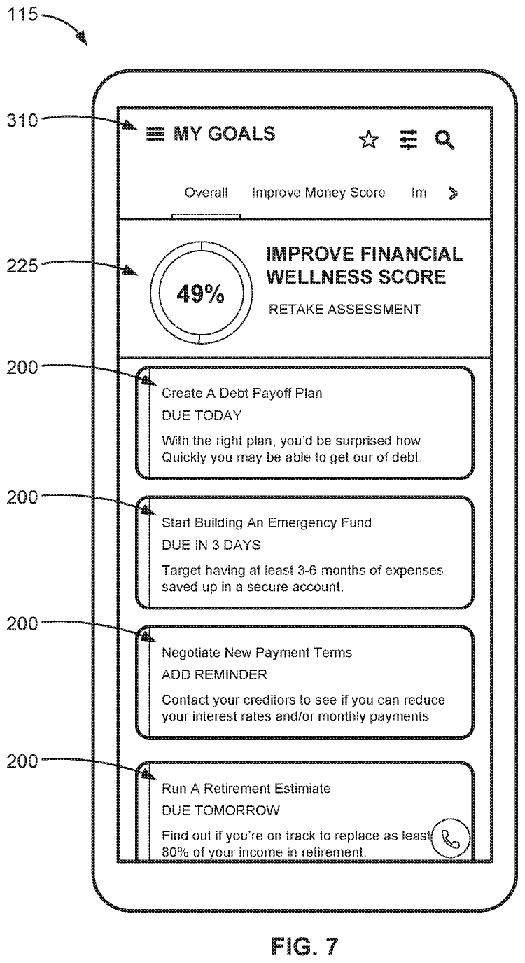

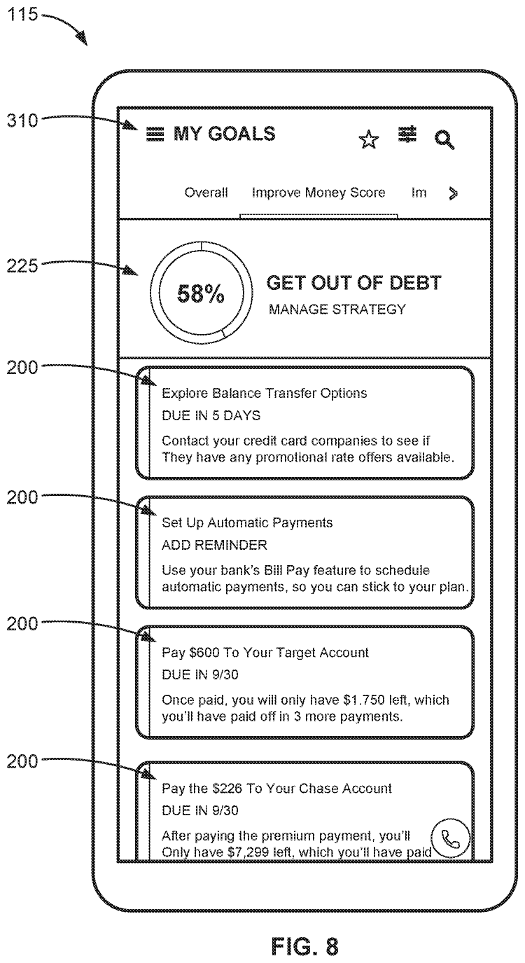

FIGS. 7 and 8 show example user interfaces 115 with different action items 200 that are prioritized based on the user's 100 input data 300. Additionally, the user's 100 wellness score 255 is displayed on FIG. 7 and the progress towards the goal 310 is displayed on FIG. 8.

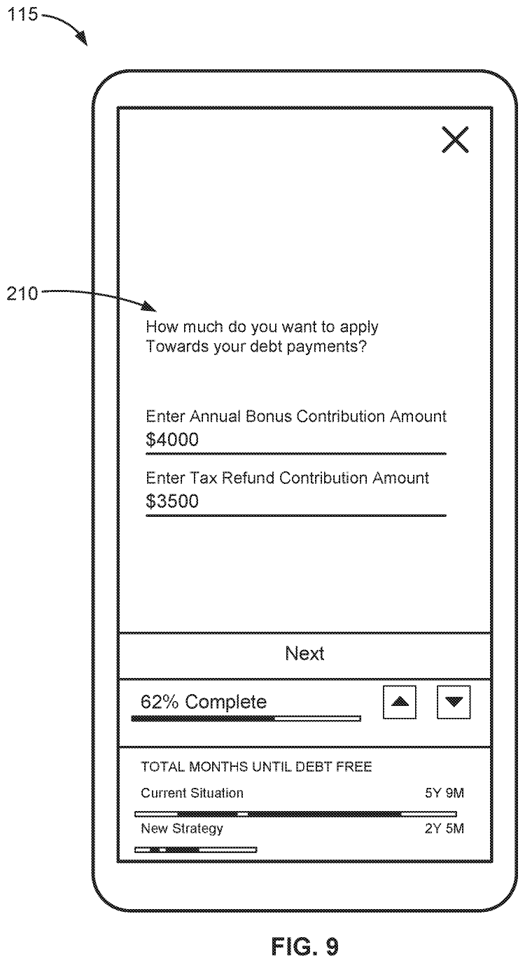

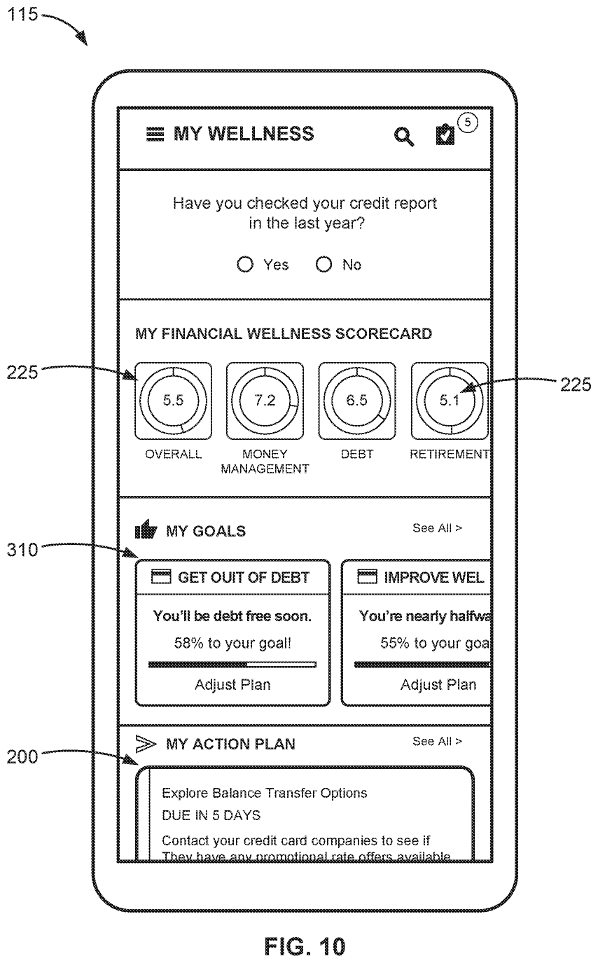

FIG. 9 shows an example of additional questions 210 relating to the goal 310 of removing debt. In this case, the field includes a space for the user 100 to enter a numerical amount in the user interface 115. FIG. 10 shows another example user interface 115 with a wellness score 255, goals 310, milestones 250, action items 200, progress and other interactive features.

### Selected Embodiments

Although the above description and the attached claims disclose a number of embodiments of the present invention, other alternative aspects of the invention are disclosed in the following further embodiments.

### Embodiment 1

A system for implementing a virtual coach, the system comprising:

a display;

an interface;

a memory containing machine readable medium comprising machine executable code having stored thereon instructions for performing a method;

a control system coupled to the memory comprising one or more processors, the control system configured to execute the machine executable code to cause the control system to:
receive, from the interface, a first set of input data comprising profile data and user goal data;
display, on the display, a first question comprising text;
receive, from the interface, a first set of answer data representing an answer to the first question;
display, on the display, a first action item based on the first set of answer data and first set of input data;
process, using a machine learning algorithm, the first set of input data, the answer data and a status of the first action item to select a second question;
display on the display, the second question comprising text;
receive, from the user interface, a second set of answer data comprising an answer to the second question; and
display on the display, a second action item based on the second set of answer data, the first set of answer data, the first set of inputs data, and the status of the first action item, and wherein the first and second action items are ranked using a second machine learning model.

### Embodiment 2

The system of embodiment 1, wherein the machine learning model is trained by receiving a training user's selection and sequence of questions based on a given input data set, answer data set, and action item status set.

### Embodiment 3

The system of embodiment 1, wherein the machine learning model comprises a decision tree, or a neural net.

### Embodiment 4

The system of embodiment 1, wherein the input data is received from the user interface as answer data based on questions presented on the interface using an initial decision tree model.

### Embodiment 5

The system of embodiment 1, wherein the wherein the machine learning model is trained based on feedback from a financial score determined based on processing a user's profile data, goal data, and a set of financial comprising quantitative value representing the user's financial liabilities.

### Embodiment 6

The system of embodiment 1, wherein the first set of answer data comprises a numerical value indicating a financial liability of the user.

### Embodiment 7

The system of embodiment 1, wherein profile data comprises age, dependents, and location.

### Embodiment 8

The system of embodiment 6, wherein the financial liability comprises at least one of: a loan, a financial account, a regular bill, an asset, or a future saving goal.

### Embodiment 9

The system of embodiment 6, wherein the input data comprises financial account password and account information for financial accounts stored on a remote database.

### Embodiment 10

The system of embodiment 1, wherein the action item status comprises a user's level of engagement with the action item comprising user interface interactions with the action item.

### Embodiment 11

The system of embodiment 10, wherein the user interface interaction comprises a total time of viewing an article hyperlinked to the action item.

### Embodiment 12

A system for implementing a virtual coach, the system comprising:

a display;

an interface;

a memory containing machine readable medium comprising machine executable code having stored thereon instructions for performing a method;

a control system coupled to the memory comprising one or more processors, the control system configured to execute the machine executable code to cause the control system to:
receive a set of input data comprising profile data, user goal data and action item status data;
display, on the display, a question comprising text;
receive, from the interface, a set of answer data representing an answer to the question;
display, on the display, either an action item or an additional question based on the output of processing the set of answer data, and the set in input data using a machine learning model trained by a training user.

### Embodiment 13

The system of embodiment 12, wherein the machine learning model is a neural net trained using back propagation.

### Embodiment 14

The system of embodiment 12, wherein the action item includes a visual interaction element that allows a user to select that an action item is competed through the interface.

### Embodiment 15

The system of embodiment 13, wherein the action item status comprises whether the user has selected that an action item is completed.

### Embodiment 16

The system of embodiment 14, wherein action items, and questions have category labels associated with one of a set of goals.

### Computer & Hardware Implementation of Disclosure

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

### CONCLUSION

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A system for implementing a virtual coach, the system comprising:
a display;
an interface;
a memory containing machine readable medium comprising machine executable code having stored thereon instructions for performing a method;
a control system coupled to the memory comprising one or more processors, the control system configured to execute the machine executable code to cause the control system to:
receive, from the interface, a first set of input data comprising profile data and user goal data;
display, on the display, a first question comprising text;
receive, from the interface, a first set of answer data representing an answer to the first question;
display, on the display, a first action item based on the first set of answer data and first set of input data;
process, using a machine learning algorithm, the first set of input data, the answer data and a status of the first action item to select a second question;
display on the display, the second question comprising text;
receive, from the user interface, a second set of answer data comprising an answer to the second question; and
display on the display, a second action item based on the second set of answer data, the first set of answer data, the first set of inputs data, and the status of the first action item, and wherein the first and second action items are ranked using a second machine learning model.

2. The system of claim 1, wherein the machine learning model is trained by receiving a training user's selection and sequence of questions based on a given input data set, answer data set, and action item status set.

3. The system of claim 1, wherein the machine learning model comprises a decision tree, or a neural net.

4. The system of claim 1, wherein the input data is received from the user interface as answer data based on questions presented on the interface using an initial decision tree model.

5. The system of claim 1, wherein the wherein the machine learning model is trained based on feedback from a financial score determined based on processing a user's profile data, goal data, and a set of financial comprising quantitative value representing the user's financial liabilities.

6. The system of claim 1, wherein the first set of answer data comprises a numerical value indicating a financial liability of the user.

7. The system of claim 1, wherein profile data comprises age, dependents, and location.

8. The system of claim 6, wherein the financial liability comprises at least one of: a loan, a financial account, a regular bill, an asset, or a future saving goal.

9. The system of claim 6, wherein the input data comprises financial account password and account information for financial accounts stored on a remote database.

10. The system of claim 1, wherein the action item status comprises a user's level of engagement with the action item comprising user interface interactions with the action item.

11. The system of claim 10, wherein the user interface interaction comprises a total time of viewing an article hyperlinked to the action item.

12. A system for implementing a virtual coach, the system comprising:
a display;
an interface;
a memory containing machine readable medium comprising machine executable code having stored thereon instructions for performing a method;
a control system coupled to the memory comprising one or more processors, the control system configured to execute the machine executable code to cause the control system to:
receive a set of input data comprising profile data, user goal data and action item status data;
display, on the display, a question comprising text;
receive, from the interface, a set of answer data representing an answer to the question;
display, on the display, either an action item or an additional question based on the output of processing the set of answer data, and the set in input data using a machine learning model trained by a training user.

13. The system of claim 12, wherein the machine learning model is a neural net trained using back propagation.

14. The system of claim 12, wherein the action item includes a visual interaction element that allows a user to select that an action item is competed through the interface.

15. The system of claim 14, wherein the action item status comprises whether the user has selected that an action item is completed.

16. The system of claim 14, wherein action items, and questions have category labels associated with one of a set of goals.
